(19) United States
(12) Patent Application Publication
(10) Pub. No.: US 2009/0066291 A1
(43) Pub. Date: Mar. 12, 2009

(54) DISTRIBUTED ENERGY STORAGE CONTROL SYSTEM

(76) Inventors: Jenn-Yang TIEN, Hsinchu City (TW); Jan-Wu Hong, Hsinchu City (TW); Sheng-Cherng Wang, Hsinchu City (TW)

Correspondence Address: RABIN & Berdo, PC, 1101 14TH STREET, NW, SUITE 500, WASHINGTON, DC, 20005, US

(21) Appl. No.: 11/876,074

(22) Filed: Oct. 22, 2007

(30) Foreign Application Priority Data
Sep. 10, 2007 (TW) 096133642

(51) Int. Cl. H02J 7/00

(52) U.S. Cl. 320/118

(57) ABSTRACT

A Distributed Energy Storage Control System (DESCS) comprised of one or a plurality of identical BMS (Battery Management System) battery unit (40), series-parallel system controller (60) and DESCS main controller (70). Each BMS battery unit (40) including a smart battery unit (10), a discharge bypass path control switch (43), a super capacitor (45), a charge bypass load (46) and charge bypass path control switch (44). This DESCS system substantially promotes the energy efficiency of battery, provides a large scale and complicated energy storage system with on-line repair or replacement of batteries, proceeds charge/discharge task uninterrupted during maintenance, and possesses high maintainability.

### BACKGROUND OF THE INVENTION

(a) Field of the Invention

The present invention is related to a distributed energy storage control system, and more particularly, to one focusing on the charge/discharge controlling and status monitoring for a large scale and complicated electrical power energy storage system. The present invention is being configured as a distributed master-slave control system. The DESCS main controller monitors and controls all conditions of the lower layered series-parallel controllers (60). The series-parallel controller (60) controls the charge/discharge sequences of all series battery units (50) in the related series-parallel system and, according to the supply capacity of power source and charge/discharge characteristics of battery cells, commands the battery strings to be charged at the maximum allowable charging current. The series battery units (50) will be grouped to be charged in turn when necessary.

For the BMS battery unit (40) nearest to the series-parallel system voltage reference line (62) is designated to be a series system controller (40′) in each series battery unit (50). During charge process, the series system controller (40′) monitors charging status of each battery in the battery string and bypasses the battery which is about to be fully charged by switching to the charge bypass load (46) one by one and enables all batteries to achieve the fully charge status at the same time. The charge bypass can save energy consumption and lower the requirement of power source to achieve a charge balance condition. Incorporate with the discharge bypass design, the energy application efficiency promoted. By monitoring the batteries, the battery can be effectively managed and prolonged service life.

While during the process of discharge, series system controller (40′) monitors discharging status of each battery in the battery string and bypasses the battery which is discharged to its lower limit by switching on the discharge bypass path control switch (43) one by one. While the voltage is in normal range, series system controller (40′) keeps the series battery unit (50) continuing to discharge uninterrupted thus the energy stored in every battery can be fully utilized and the discharge efficiency for stored energy can be promoted substantially. The discharge bypass path control switch (43) can isolate a fault battery or an empty battery so that to prevent the battery from being reverse charged and avoid the danger of overheat or explosion.

In order to simply the maintenance of a large and complicated energy storage system, the present invention provides a design of knife/overload protection switch (47). This design gives the BMS battery unit (40) in a series-parallel system a way to be isolated for maintenance on-line, charging, discharging, or balancing the battery in advance. The maintainability of the whole system promoted substantially. Meanwhile, a concise wiring lowers down the system's complexity and cost of construction.

(b) Description of the Prior Art

For a configuration of series connected multiple batteries, traditional technology provides a design of charge bypass switch and bypass load to achieve full charge balance for every battery. For discharge, the old technology did not consider the design of discharge bypass so that when a battery in the series connected battery system is degraded, fault, or reached its lower discharge limit, since the requirement of over discharge protection for battery, the battery must be turned off and then the output power of the series battery string be turned off also. The total usable energy of the series battery string will be limited by the one battery with bad characteristics. The energy stored in the other sound batteries with higher capacity will no longer be usable. Besides, in the series battery system, a fault battery without discharge bypass path will be reverse charged during discharge process and result in hazards. The present invention develops the discharge bypass function to provide the energy usage a better discharge way and substantially promote the energy efficiency for series battery unit. The more batteries a series battery system has, the higher discharge efficiency advantages of this remarkable invention has.

### SUMMARY OF THE INVENTION

The main purpose of the present invention is to provide a Distributed Energy Storage Control System (DESCS). This DESCS system substantially promotes the energy efficiency of battery, provides a large scale and complicated energy storage system with on-line repair or replacement of batteries, proceeds charge/discharge task uninterrupted during maintenance, and possesses high maintainability.

The purpose of the present invention can achieve by the followings:

A Distributed Energy Storage Control System (DESCS) of the present invention relates to a series-parallel connection of multiple BMS battery units (40) and upper layer controllers. The diagram of the system is shown in FIG. 5. The mains include one DESCS main controller (70), a DESCS transmission interface (71), several series-parallel controllers (60), several series-parallel transmission interfaces (22), several series battery units (50) under the control of a series-parallel controller (60), a series battery unit (50) formed of several BMS battery units (40), and a series system controller (40′) that is a BMS battery units (40) nearest to the series-parallel system voltage reference line (62). The series system controller (40′) monitors the charge/discharge of each BMS battery unit (40) through an Isolated Transmission Interface (23). Also, the series system controller (40′) communicates with the series-parallel controller (60) through a Series/Parallel Transmission Interface (22).

In a DESCS, the battery and circuit of all the BMS battery units (40) in a series-parallel system are identical. FIG. 1 is a diagram of a BMS battery unit with charge and discharge bypass paths. FIG. 2 depicts the detail circuit of the BMS battery unit (40). The BMS battery unit (40) is composed of a smart battery unit (10), charge bypass circuit and discharge bypass circuit. The charge bypass circuit is made up of a charge bypass path control switch (44) and a charge by-pass load (46), while the discharge bypass circuit is made up of a discharge bypass path control switch (43) and a super capacitor (45). In the smart battery unit (10), there is an essential energy storage device (a battery cell (30)), a sensor switch device (25), and a controller (20).

The basic series-parallel DESCS is as shown in FIG. 3. In this series system, the reference voltage for each BMS battery unit (40) has different potential so that the signals transmitted between the controllers (20) must be isolated from each other. The BMS battery unit (40) that has the reference voltage same as that of the series-parallel system voltage reference line (62) is designated as the series system controller (40′). Each BMS battery unit (40) has its own unique communication address and the transmission interface between BMS battery units (40) is configured by the software to be a master-slave framework. The series-parallel controller (60) communicates and controls each series system controller (40′) through the series-parallel transmission interface (22). The charge and discharge of the series-parallel system are all at the same time via the series-parallel system power/load bus bar (61) and the voltage reference line (62). The series-parallel controller (60) controls the output voltage/current of the power source (64) via the energy regulator (65) to charge the serial battery units (50) by constant voltage (CV) or by constant current (CC) method. The charging power source (64) can be diversified such as the power comes from a power plant, a vehicle generator, a solar power tower, a thermoelectric generator, a wind/hydraulic power generator or other devices that convert energy to electric power etc.

As shown in FIG. 7, the controller (20) is composed of a microcontroller unit (21), a series-parallel transmission interface (22), an isolated transmission interface (23), a wireless transmission interface (24), a display unit (26), a data access unit (27), a synchronization unit (28) and a real time clock (29). The controller (20) detects the voltage and current of a battery in charging or detects the voltage of a static battery and the temperature of the battery to analysis the energy storage and health status of a battery and controls the battery cell (30) to utilize the charge/discharge and charge/discharge bypass. During the process of charging, when the battery is about to be full charged or a fault battery is found, the mechanism of charge bypass will be initiated. During the process of discharging, when the battery is reached its bottom limit of capacity or a fault battery is found, the mechanism of discharge bypass will be initiated.

When a battery is degraded and unusable, the related BMS battery unit (40) will be isolated and a warning message will be issued. This early warning will make the DESCS system to be maintained timely before the system break down.

The number of battery in a series-parallel battery system is flexible. The series number of battery in a series battery unit (50) is flexible and the parallel number of series battery unit (50) in a series-parallel battery system is also flexible. The amount of the battery is according to the energy storage requirement of a system. The configuration of the system is predefined.

Refer to FIG. 4. Before join together a series battery unit (50) with the series-parallel system power/load bus bar (61), a knife/overload protection switch (47) is series connected in between. The knife/overload protection switch (47) can conduct to the series-parallel system power/load bus bar (61) or to a stand alone external path (63) for charge/discharge. After one knife/overload protection switch (47) is switched off, the other series battery units (50) in the series-parallel system continue to carry out their charge/discharge process. This provides the system with a capability of on-line maintenance for the series battery unit (50). In a large-scale energy storage system, this feature provides convenience and flexibility for the operation of maintenance and installation.

The design of the external path (63) for charge/discharge provides the system with a flexible configuration of charge/discharge. The isolated series battery unit (50) can proceed to charge/discharge independently via this external charge/discharge path (63) and will not interfere with the charge/discharge proceeded by the system through the series-parallel system power/load bus bar (61). The suitable independent charging power supply source which goes through the external path (63) can be a power appropriate regulated from the output of a public power plant, an alternator on vehicle, a solar energy power tower, a thermal-electric generator, a wind/hydraulic power generator, or from the other device which transfers energy to electric power, etc. The source for charging power supply in this system can be diversified. In this system there can be some of the series battery units (50) in discharge mode and some in charge mode simultaneously.

In order to charge to maximum capacity for every battery in the present invention of DESCS system, there are two ways to accomplish the purpose. The first one is to realize it through charge bypass control of the BMS battery unit (40) and voltage control of the charger. The other one is to realize it through voltage control of the charger only.

In the present invention of DESCS system, through the way of controls over charge/discharge, a best efficiency to make use of the energy can be achieved in the configuration of parallel connected of multiple series battery units (50) with charge/discharge bypass path feature. In this configuration every series battery unit (50) can obtain the maximum available power. In this DESCS system, each series battery unit (50) can be turned off or cut out respectively while the system is still keep running until all BMS battery units (40) are all turned off.

With the charge and discharge bypass controls, each battery in the system can obtain its maximum energy storage. The DESCS can deliver its maximum energy to the load.

In the situation that the voltage, the current and the temperature are monitored, the fault series battery units (50) and specific BMS battery units (40) can be isolated easily.

In the series battery unit (50) system, a concise bonding and connecting method between the BMS battery units (40) simplifies the wiring of the system and the processing of the energy. Moreover, the system possesses the flexibility of configuration changing.

In FIG. 6, the controller (20) adopts a wireless transmission interface (24) as a main control and communication interface for the DESCS system. Each wireless device in the DESCS system has its unique address. The wireless devices in DESCS main controller (70) and in all series system controllers (40′) are joined together to form a wireless network. The DESCS main controller (70) controls the series system controllers (40′) directly by commands transmitted wirelessly. The wireless devices in the series system controllers (40′) and in all related series connected BMS battery units (40) are also joined together to form a wireless network. The series system controllers (40′) controls the related series connected BMS battery units (40) by commands transmitted wirelessly also.

Under the present of wireless configuration, the signal cable wirings between series system controller (40′) and BMS battery units (40) or between series system controllers (40′) and the DESCS main controller (70) are all removed. The concise configuration and removal of signal cable connections in installation expedite the maintenance of the system.

### BRIEF DESCRIPTION OF THE DRAWINGS

FIG. 1 is a diagram of a BMS battery unit with charge and discharge bypass paths.

FIG. 2 depicts the detail circuit of a BMS battery unit.

FIG. 3 depicts an Energy Storage Control System (ESCS) formed of BMS battery units in series and parallel (1).

FIG. 4 depicts an ESCS formed of BMS battery units in series and parallel (2).

FIG. 5 depicts a General Distributed Structure of an ESCS, DESCS.

FIG. 6 depicts a system framework of a DESCS incorporating the wireless transmission interface.

FIG. 7 depicts a smart battery unit and its peripheral.

FIG. 8 is an example of scatternet topology.

FIG. 9 depicts a series battery units and the flowing load current.

### DETAILED DESCRIPTION OF THE PREFERRED EMBODIMENTS

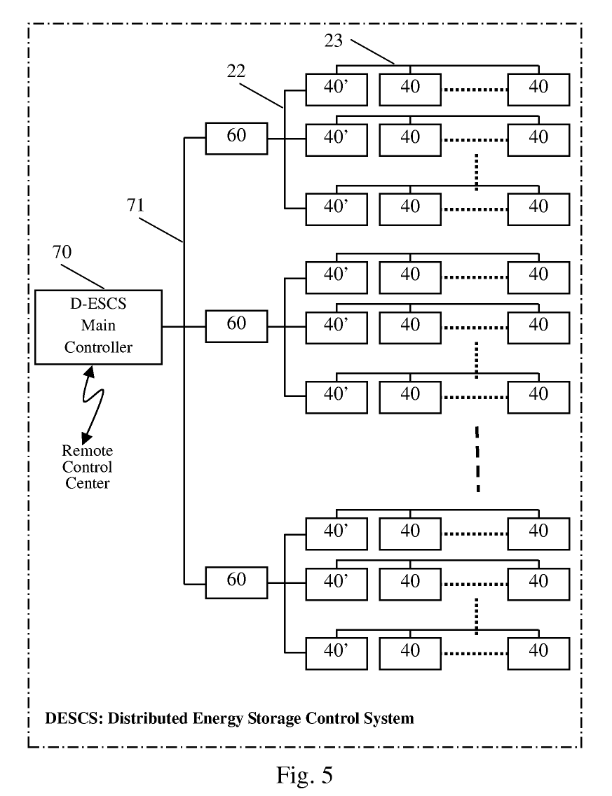

A Distributed Energy Storage Control System (DESCS) of the present invention relates to a series-parallel connection of multiple BMS battery units (40) and upper layer controllers. The diagram of the system is shown in FIG. 5. The mains include one DESCS main controller (70), a DESCS transmission interface (71), several series-parallel controllers (60), several series-parallel transmission interfaces (22), several series battery units (50) under the control of a series-parallel controller (60), a series battery unit (50) formed of several BMS battery units (40), and a series system controller (40′) that is a BMS battery units (40) nearest to the series-parallel system voltage reference line (62). The series system controller (40′) monitors the charge/discharge of each BMS battery unit (40) through an Isolated Transmission Interface (23). Also, the series system controller (40′) communicates with the series-parallel controller (60) through a Series/Parallel Transmission Interface (22).

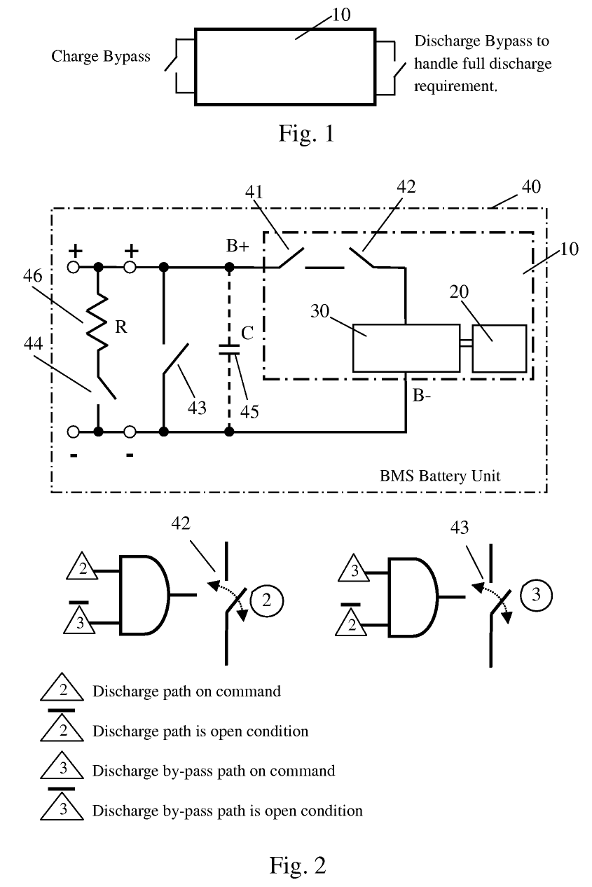

In a DESCS, the battery and circuit of all the BMS battery units (40) in a series-parallel system are identical. Each series-parallel system can be an independent system that has its own series-parallel system power/load bus bar (61) and voltage reference line (62). The specific voltage system of each series-parallel system is determined by the DESCS main Controller (70). Also, all the series-parallel system can be joined together to form a power system of single output voltage. The DESCS system has a characteristic of diversified voltage supply. FIG. 1 is a diagram of a BMS battery unit with charge and discharge bypass paths. FIG. 2 depicts the detail circuit of the BMS battery unit (40). The BMS battery unit (40) is composed of a smart battery unit (10), charge bypass circuit and discharge bypass circuit. The charge bypass circuit is made up of a charge bypass path control switch (44) and a charge by-pass load (46), while the discharge bypass circuit is made up of a discharge bypass path control switch (43) and a super capacitor (45). In the smart battery unit (10), there is an essential energy storage device (a battery cell (30)), a sensor switch device (25), and a controller (20). The sensor switch device (25) is a charge path control switch (41) series connected with a discharge path control switch (42). The control logic of discharge path control switch (42) and discharge bypass path control switch (43) is illustrated in FIG. 2 and the logic is designed to be exclusive logic.

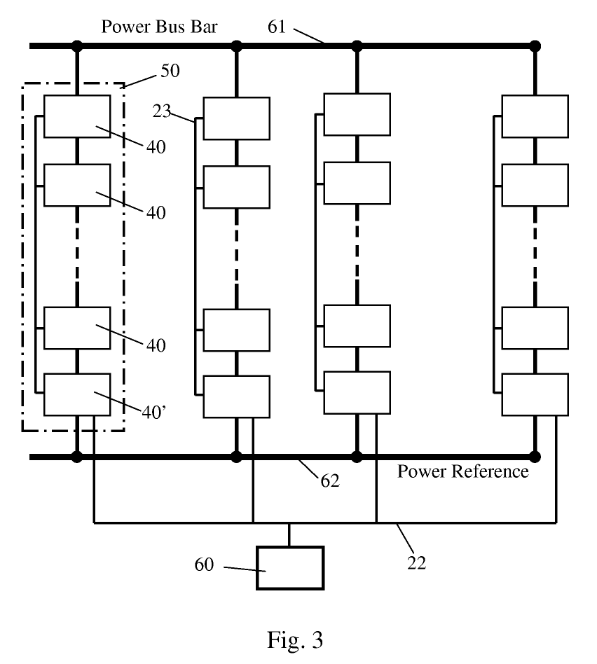

As shown in FIG. 3, the basic series-parallel DESCS is formed by connect BMS battery units (40) in series first and then connect several series battery units (50) in parallel. Several BMS battery units (40) connect in series to form a series battery unit (50). In this series system, the reference voltage for each BMS battery unit (40) has different potential so that the signals transmitted between the controllers (20) must be isolated from each other. An isolated transmission interface (23) is used to overcome the reference potential difference problem and to make the signal transmission for communication and control feasible. The BMS battery unit (40) that has the reference voltage same as that of the series-parallel system voltage reference line (62) is designated as the series system controller (40′). In a series battery unit (50), each BMS battery unit (40) has its own unique communication address and the transmission interface between BMS battery units (40) is configured by the software to be a master-slave framework. By the interaction and control between series system controller (40′) and BMS battery units (40), the serial system can be charged safely and efficiently and can be discharged safely. The battery cell has the best maintenance by avoiding overcharge or over discharge and prolongs the life of service. The series-parallel controller (60) communicates and controls each series system controller through the series-parallel transmission interface. The charge and discharge of the series-parallel system are all at the same time via the series-parallel system power/load bus bar (61) and the voltage reference line (62). The series-parallel controller (60) controls the output voltage/current of the power source (64) via the energy regulator (65) to charge the serial battery units (50) by constant voltage (CV) or by constant current (CC) method. The charging power source (64) can be diversified such as the power comes from a power plant, a vehicle generator, a solar power tower, a thermoelectric generator, a wind/hydraulic power generator or other devices that convert energy to electric power etc. According to the output power/energy capacity of the power source (64) and the highest or lowest charge current limit of the BMS battery unit (40), the series battery units (50) are grouped to be charged in turn when necessary determined by the software of the series-parallel controller (60).

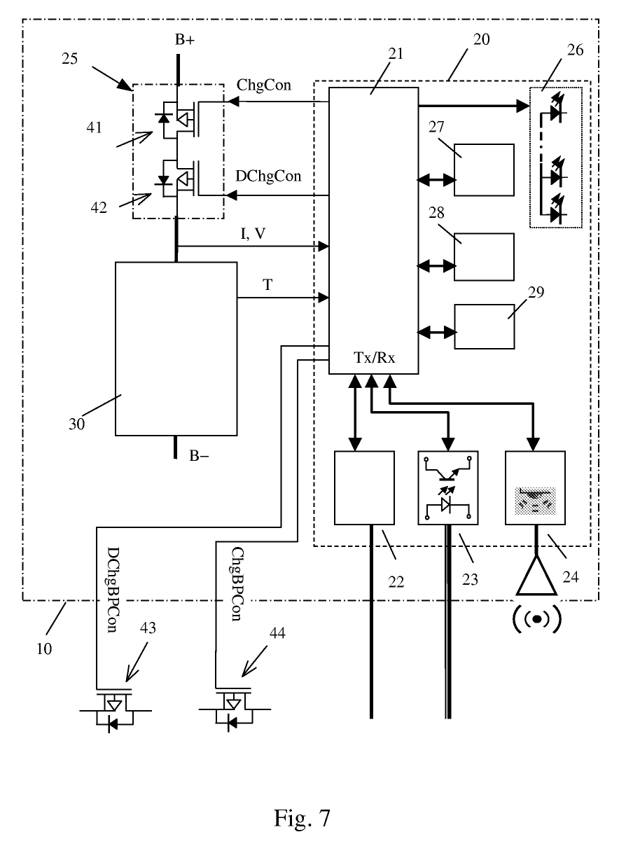

As shown in FIG. 7, the controller (20) is composed of a microcontroller unit (21), a series-parallel transmission interface (22), an isolated transmission interface (23), a wireless transmission interface (24), a display unit (26), a data access unit (27), a synchronization unit (28) and a real time clock (29). A microcontroller unit (21) is a microprocessor with a built-in flash memory, two serial ports, an I²C bus, multiple inputs and multiple outputs of analog to digital converter (ADC). The series-parallel transmission interface (22) is an interface with the function of broadcasting such as a MultiDrop Bus. The isolated transmission interface (23) use optical coupling devices to isolate the interface such as I²C bus which has the function of master-slave transmission. The data transmission between the controller and other control module utilizes the current loop mode of optical coupling device. This method can isolate the noise between control modules and avoid the influence of a failed module on communications amid the other modules by isolate any failed module physically. The isolating effect of optical coupling devices can solve the problem of voltage difference in a series battery system. The wireless transmission interface (24) is a short range and low power interface such as Bluetooth/Zigbee/IR wireless interfaces. The interface transmits and receives control/data signals of controllers wirelessly to take the advantages of reference voltage isolation and reduce the complexity of wiring tremendously. Besides, it speeds up the assembling and disassembling of batteries and makes the maintenance more convenient. The display unit (26) is composed of LEDs to indicate the status of a battery module. The display indicates charging, full charged, discharging, charge bypass, discharge bypass, and fault etc. The data access unit (27) stores all information of exceptions for battery status inquiring and failure analysis during maintenance. The synchronization unit (28) provides a accurate clock synchronized for data storage. A real time clock (29) provides date/time information for data records. Inputs of analog to digital converter are used to measure battery voltage, current, and temperature.

In FIG. 7, the controller (20) detects the voltage and current of a battery in charging or detects the voltage of a static battery and the temperature of the battery to analysis the energy storage and health status of a battery. By the control of charge path control switch (41), discharge path control switch (42), discharge bypass path control switch (43), and charge bypass path control switch (44), the controller controls the battery cell (30) to utilize the charge/discharge and charge/discharge bypass. Also refer to FIG. 2. While the BMS battery unit (40) is in normal charge/discharge mode, the charge bypass path control switch (44) and discharge bypass path control switch (43) are turned off. While the serial battery unit (50) completed its charge or discharge, the series system controller (40′) commands each BMS battery unit (40) to turn on or turn off the charge/discharge switches and to turn on or turn off the charge/discharge bypass switches.

During the process of charging, when the battery is about to be full charged or a fault battery is found, the mechanism of charge bypass will be initiated. While the BMS battery unit (40) is in the charge bypass status, the charge bypass path control switch (44) is turned on and discharge bypass path control switch (43) is turned off. The charge bypass load (46) which consumes tiny power provides a bypass path for the battery which is about to be full charged and keeps the other batteries in the series battery unit (50) to be charged in full current to achieve the balance of series connected batteries.

During the process of discharging, when the battery is reached its bottom limit of capacity or a fault battery is found, the mechanism of discharge bypass will be initiated. While the BMS battery unit (40) is in the discharge bypass status, the charge bypass path control switch (44) is turned off and discharge bypass path control switch (43) is turned on and the sensor switch device (25) is turned off to disconnect and separate the battery cell (30) to avoid the catastrophe caused by reverse charge of a battery. Because of actively control of discharge bypass, the balance will be achieved between battery cells and get rid of safety problem.

### The Algorithm of Discharge Bypass Control is Illustrated as Following:

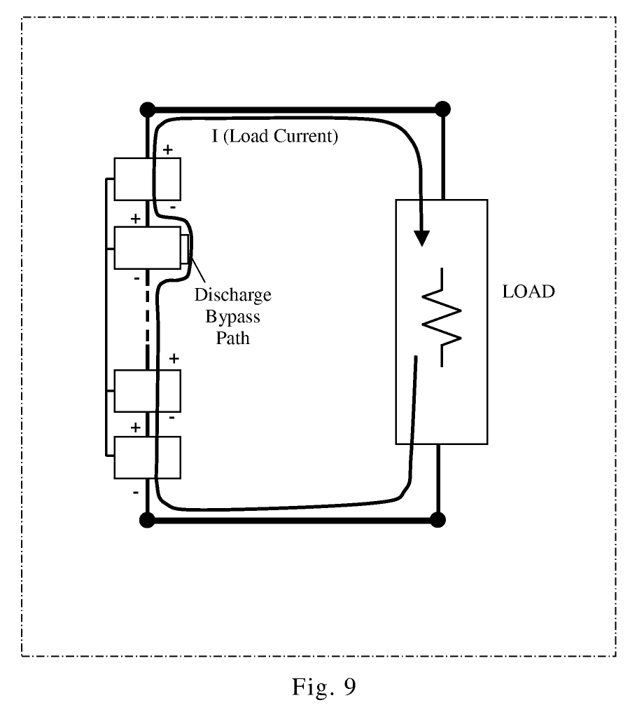

1. Under the framework of a series battery unit (50), when one of the BMS batteries (40) has reached its end of discharge (EOD) condition, the local controller (20) will issue a discharge bypass command to the BMS battery unit (40). The BMS battery unit (40) will then turns off its discharge path (i.e. open the discharge path control switch) and turns on its discharge bypass path (i.e. close the discharge bypass path control switch). The energy capacity of this BMS battery unit (40) which has reached its EOD will be the lowest limit preset. Under this situation, the circuit between positive end (+) and negative end (−) of this BMS battery unit (40) (see the “+” and “−” signs in FIG. 2) becomes almost short and then keeps the battery cell (30) from being reverse charged by the discharge current flowing through it (see FIG. 9) and keeps the battery safe. After the discharge bypass mechanism is activated, the series battery unit (50) can keep the discharge output current supplying and will not be limited by the one battery which has lower capacity. On the basis of the application of discharge bypass path, each battery in the series connected battery system can be made full use of its storage energy. This provides the most effective way for a series battery system to use the storage energy. The old techniques do not have the design of discharge bypass path. When the series battery system is in discharge mode, because of the necessity of the over discharge (OD) protection for each battery, the whole capacity of a series battery system is limited by the battery which has the worst capacity feature in the series. When OD protection happened, the series battery system will cease its output of energy supply and the remaining energy in the other higher energy capacity batteries in the series battery system will no long be usable. The discharge bypass design of the present invention overcomes the drawback of unusable remaining energy mentioned above. The more batteries a series battery system has, the higher discharge efficiency advantages of this remarkable invention has.
2. Between the positive terminal (B+) and negative terminal (B−) of the battery (refer to the B+ and B− terminals in FIG. 2), a super capacitor (45) is parallel connected with the battery. The discharge path control switch (42) must be turned off before turn on the discharge bypass path control switch (43) to avoid an accidental huge current discharge from the battery cell caused by a transient short circuit between terminal B+ and terminal B−. While the discharge path had turned off and the discharge bypass path has not turned on yet, the energy contained in this super capacitor (45) sustains the discharge during the switching period. During switching on the discharge bypass mechanism for the series battery system, the present invention ensures that the power supply of this system will get rid of the power dip or interruption conditions. For a switching device adopts the solid state switch, the switching period of the above discharge bypass mechanism will be ranked in an order of μs. The super capacitor can recover the power supply of this period of time. In a series-parallel system which is constructed from parallel connected of multiple series battery units (50), the other series battery units (50) that do not activate the discharge bypass mechanism will continue to supply the power and supersede the effect of super capacitor of a series battery unit (50) in which the mechanism is activated.
3. When too many batteries in a series battery unit (50) activate their discharge bypass mechanism and the discharge current reaches a value near the preset cease discharge condition, the discharge current of the series battery unit (50) will be in short supply. The series battery unit (50) can then be turned off to avoid it adversely going into a state of charging mode because of a lower output voltage and avoid dissipating the energy of whole series-parallel system.

When a battery is degraded and unusable, the related BMS battery unit (40) will be isolated and a warning message will be issued. This early warning will make the DESCS system to be maintained timely before the system break down.

The number of battery in a series-parallel battery system is flexible. The series number of battery in a series battery unit (50) is flexible and the parallel number of series battery unit (50) in a series-parallel battery system is also flexible. The amount of the battery is according to the energy storage requirement of a system. The configuration of the system is predefined.

Every BMS battery unit (40) has a unique communication address. The amount and allocation of the addresses for BMS battery units (40) in the system are predefined as a fixed master-slave framework in accordance with the whole DESCS system.

Main Functions of the Controller (20):
1. (Initialization Procedure) After power on, read data from the flash memory and determine the configuration of the BMS battery unit (40) (upper/lower limits of the charge/discharge voltage and current, capacity of battery, upper limit of temperature);
2. (Charge/Discharge Management) Receive commands from series system controller (40′) for the control of charge switch to proceed charge and suspend discharge. During the charge process, measure the charge voltage and charge current and measure the static voltage while charge process suspended. On a regular time schedule, measure the battery cell temperature to judge the status of battery cell: whether full charged, over charged or already reach the lower limit of discharge. Initiate the charge/discharge bypass control function according to the charge/discharge bypass conditions preset.
3. (Reply Statuses) Receive commands from series system controller (40′) to reply statuses of charge voltage, charge current, static voltage, charge/discharge bypass initiating condition, energy storage of the battery, battery cell temperature/status, abnormal status of battery and the time and date it occurs.
4. (Abnormal Status Handling) When a battery abnormal status is determined, show the failure indication on the display unit (114), store the synchronous time/time-date, data measured, and status code to the flash memory for read out during future maintenance and causes analysis.
5. Under the conditions preset and not rely on the command for action from upper layer controller, control the BMS battery unit (40) for self protection.

Main Functions of Series System Controller (40′):

In addition to the functions of controller (20), the series system amin controller has the following functions:
1. (Initialization Procedure) After power on, read system configuration transmitted from the series-parallel controller (60), including total number of series connected BMS battery units (40), upper/lower limits of the charge/discharge voltage and current of the series battery units (50), capacities of the series battery units (50);
2. (Series Charge Management) Receive commands from series-parallel controller (60) to start the charge of series battery units (50). In a series battery unit (50), all the BMS battery units (40) are charged at the same time. For the BMS battery unit (40) which is about to be full charged will switch on the charge bypass mechanism and keep it in a small current charge mode by parallel with a bypass load resister. The other BMS battery units (40) are still kept in maximum current charge mode. The BMS battery units (40) in a series battery unit (50) will reach the charge balance by this way and all of the BMS battery units (40) can be charged fully.
3. (Series Discharge Management) Receive commands from series-parallel controller (60) to start the discharge of series battery units (50). In a series battery unit (50), all the BMS battery units (40) are discharged at the same time. For the BMS battery unit (40) which is discharged to the lower discharge limit preset will switch on the discharge bypass mechanism and secede from the discharge procession temporary. The other BMS battery units (40) are kept in discharge mode till they reach the lower discharge limit preset. In this way, the purpose to fully discharge and completely use the energy stored in every battery can be realized.
4. (Status Inquiry) According to the amount of battery in the series system and the configuration of the battery, request the controllers (20) to reply the information of newest status in turn. Including charge voltage, charge current, static voltage, charge/discharge bypass, energy stored in the battery cell, temperature and status of battery cell, abnormal condition of battery cell and the time/date it happened.
5. (Failure Analysis, Management and Reply) According to the information requested, judge the status of each battery, isolate the failed battery from the series system by the bypass path and issue the warning and fault information.
6. (Reply Status) Provide real time information of the series system to the series-parallel controller (60). Including the calculated available capacity of total energy stored in the series system, available capacity of energy stored in each BMS battery unit (40), the status of charge/discharge bypass switching conditions, health status, warning information, fault information, battery abnormal status and time/date it happened, etc.

Main Functions of Series-Parallel Controller (60):
1. (Initialization Procedure) After power on, read data from built-in flash memory and confirm the series-parallel system configuration, including total number of series battery units (50), upper/lower limits of the charge/discharge voltage and current of each series battery unit (50), power supply capacity of power source (64), parameter tuning ranges of energy regulator (65);
2. (Charge/Discharge Management) According to the power supply capacity of the power source (64) and upper/lower limits of the charge/discharge voltage and current of each series battery unit (50), allot the charge current to groups of series battery units (50) in turn. For the series battery unit (50) which completes its charge process will secede from the in turn charge procession temporary. The other series battery units (50) are kept in the charging rotation till the battery capacity balance to be reached. While discharging, switch off the series battery unit (50) which is completed its discharge process one by one till the series batteries are all switched off.
3. (Status Inquiry) According to the configuration of each series battery unit (50), request the series system controllers (40′) to reply the information of newest status in turn. Including total available energy stored in the series battery system, total available energy storage capacity of each BMS battery unit (40), the charge/discharge bypass conditions of all batteries, battery health condition, warning information, fault information, battery abnormal conditions and the time/date it happened, and actions to take, etc.
4. (Failure Analysis, Management and Reply) According to the information requested, judge the external path (63) switching conditions and abnormal status of each series battery unit (50). Provide real time information of series-parallel system to DESCS main controller (70), including calculated result of total available capacity of the energy stored in the series-parallel system, the available capacity of each series battery unit (50) and its external path (63) switching condition, health and charge/discharge bypass conditions of each BMS battery unit (40), warning information, fault information, battery abnormal conditions and the time/date it happened, and actions to take, etc.

Main Functions of DESCS main Controller (70)
1. (Initialization Procedure) After power on, read data from data storage device and confirm the DESCS system configuration, including the quantity of series-parallel system, the capacity of each series-parallel system, upper limit of charge voltage and lower limit of discharge voltage of each series-parallel system, etc;
2. (Status Inquiry) According to the configuration of each series-parallel system, request the series-parallel controller (60) to reply the information of newest status in turn. Including total available energy stored in the series-parallel system, total available energy stored in each series battery unit (50) and its external path (63) switching condition, health conditions and charge/discharge conditions of all batteries, warning information, fault information, battery abnormal conditions and the time/date it happened, and actions to take, etc.
3. (System State Monitoring) According to the status requested, judge the status of each series-parallel system and all the batteries. Show all real time information on the monitor.
4. (Reply to Remote Control Center) Provide real time information of DESCS system to the remote control center, including calculated results of the available energy stored in the DESCS system, total available energy stored in the series-parallel system, total available energy stored in series battery units (50) of the series-parallel battery system, health conditions of all batteries, warning information, fault information, battery abnormal conditions and the time/date it happened, and actions to take, etc.

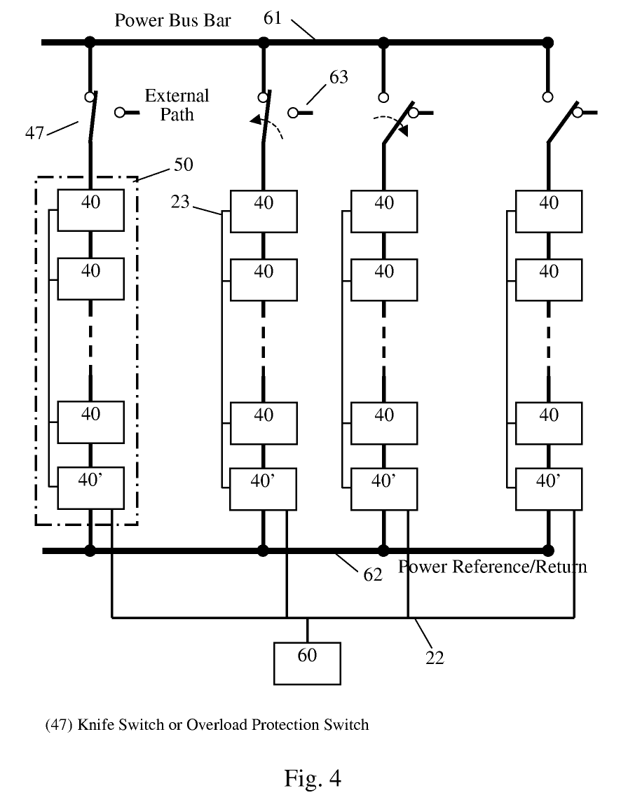

Refer to FIG. 4. Before join together a series battery unit (50) with the series-parallel system power/load bus bar (61), a knife/overload protection switch (47) is series connected in between. The knife/overload protection switch (47) is to manage the input (charge) and output (discharge) path control of a series battery unit (50). The knife/overload protection switch (47) can conduct to the series-parallel system power/load bus bar (61) or to a stand alone external path (63) for charge/discharge. The series-parallel system power/load bus bar (61) can be a common integral bulk charger for the system or a system discharge load. The external path (63) for charge/discharge can be a stand alone charging power source or discharging load. After one knife/overload protection switch (47) is switched off, the other series battery units (50) in the series-parallel system continue to carry out their charge/discharge process. This provides the system with a capability of on-line maintenance for the series battery unit (50) while the system is running uninterrupted. When a series battery unit (50) is repaired or replaced, it can be directly bond to the series-parallel system power/load bus bar (61) to perform the charge/discharge process while the voltage/capacity allowed. Also, it can be charged or discharged via the external path (63) to a balanced voltage for the system at first and then parallel connected to the series-parallel battery system. Before the series battery unit (50) mentioned above being parallel connected to the system, the charge/discharge control switches and the charge/discharge bypass control switches of each BMS battery unit (40) are all turned off as is a preset configuration. The above parallel connecting will not affect the operation of the system. The suitable time to start to charge the related series battery unit (50) is determined by the software of the series-parallel controller (60). In a large-scale energy storage system, this feature provides convenience and flexibility for the operation of maintenance and installation.

The design of the external path (63) for charge/discharge provides the system with a flexible configuration of charge/discharge. While the energy storage system proceeds to its charge/discharge, the isolated series battery unit (50) can proceed to charge/discharge independently via this external charge/discharge path (63) and will not interfere with the charge/discharge proceeded by the system through the series-parallel system power/load bus bar (61). The suitable independent charging power supply source which goes through the external path (63) can be a power appropriate regulated from the output of a public power plant, an alternator on vehicle, a solar energy power tower, a thermal-electric generator, a wind/hydraulic power generator, or from the other device which transfers energy to electric power, etc. The source for charging power supply in this system can be diversified. In this system there can be some of the series battery units (50) in discharge mode and some in charge mode simultaneously.

In order to charge to maximum capacity for every battery in the present invention of DESCS system, there are two ways to accomplish the purpose:

The first one is to realize it through charge bypass control of the BMS battery unit (40) and voltage control of the charger.

The other one is to realize it through voltage control of the charger only. When one BMS battery unit (40) in the series battery unit (50) is being charged about to the upper limit value preset, the series system controller (40′) will issue a command to ask the charger to lower down its charging voltage. The series battery unit (50) keeps being charged in this way until all the BMS battery units (40) are being charged to their upper limit value preset respectively. In this way of charging, a lot of energy can be saved by the charge bypass path and can keep a low level of thermal generation. This is the best way of energy utilization in a configuration without the design of discharge bypass control.

In the present invention of DESCS system, through the way of controls over charge/discharge, a best efficiency to make use of the energy can be achieved in the configuration of parallel connected of multiple series battery units (50) with charge/discharge bypass path feature. In this configuration every series battery unit (50) can obtain the maximum available power. In this DESCS system, each series battery unit (50) can be turned off or cut out respectively while the system is still keep running until all BMS battery units (40) are all turned off.

With the charge and discharge bypass controls, each battery in the system can obtain its maximum energy storage. The DESCS can deliver its maximum energy to the load.

In the situation that the voltage, the current and the temperature are monitored, the fault series battery units (50) and specific BMS battery units (40) can be isolated easily.

In the series battery unit (50) system, a concise bonding and connecting method between the BMS battery units (40) simplifies the wiring of the system and the processing of the energy. Moreover, the system possesses the flexibility of configuration changing.

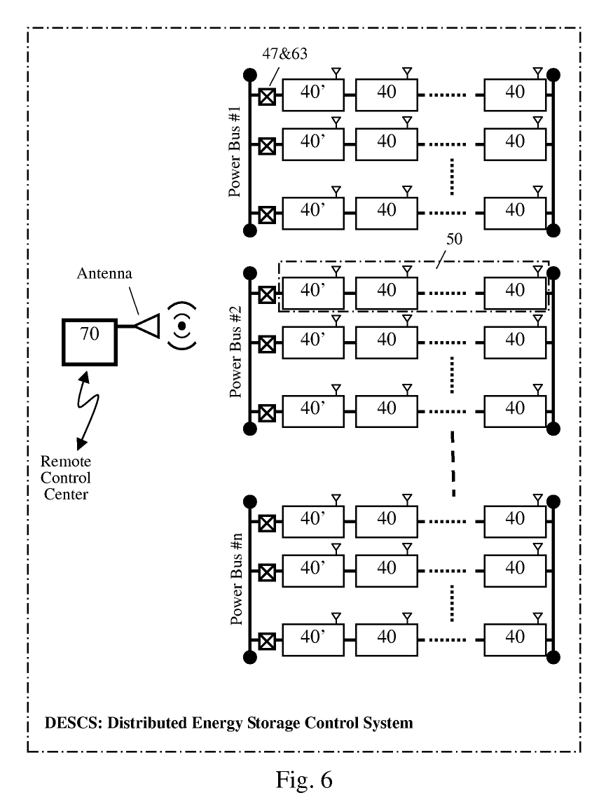

In FIG. 6, the controller (20) adopts a wireless transmission interface (24) as a main control and communication interface for the DESCS system. Each wireless device in the DESCS system has its unique address. The category (master or slave) and address designation are predefined and assigned in accordance with the system configuration. The wireless devices in DESCS main controller (70) and in all series system controllers (40′) are joined together to form a wireless network. The DESCS main controller (70) controls the series system controllers (40′) directly by commands transmitted wirelessly. The wireless devices in the series system controllers (40′) and in all related series connected BMS battery units (40) are also joined together to form a wireless network. The series system controllers (40′) controls the related series connected BMS battery units (40) by commands transmitted wirelessly also.

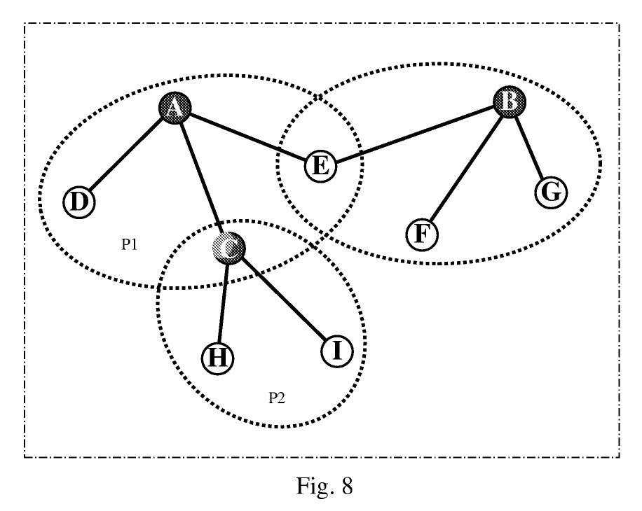

The wireless network topology is as shown in FIG. 8. Multiple wireless devices are able to connect with each other to form a piconet in an ad-hoc manner. Multiple piconets join together to form a larger network known as a scatternet in an ad-hoc manner, too. Wireless devices have point-to-multipoint capability in order to engage in scatternet communication, and several piconets can be connected to each other through one scatternet. A single wireless device may participate as a slave in several piconets, but can only be a master in one piconet. FIG. 8 shows an example of a scatternet consisting of three separate piconets, P1, P2 and P3. Each piconet is controlled by a separate master (devices A, C and E) and contains one or more slaves. Note that device C, which connects P1 and P2, is a slave in one piconet (P1) and a master in the other (P2). The wireless device has the master and slave roles switch ability. In FIG. 6, all the wireless devices in the DESCS form a scatternet. The DESCS main controller (70) and multiple series system controllers (40′) form a piconet and the DESCS main controller (70) is the master of this piconet. The wireless devices in each set of series BMS battery unit (50) form a piconet, too, and the series system controller (40′) is the master of this piconet. The DESCS main controller (70) piconet is the upper layer piconet and the series system controller (40′) piconet is the lower layer one. The upper layer and lower layer piconets connect to each other through the series system controller (40′). The series system controller (40′) is the slave of upper layer piconet and the master of the lower layer one.

Under the present of wireless configuration, the signal cable wirings between series system controller (40′) and BMS battery units (40) or between series system controllers (40′) and the DESCS main controller (70) are all removed. The concise configuration and removal of signal cable connections in installation expedite the maintenance of the system. As a result of the removal of the signal cabling between controllers, there is no potential difference problem between controllers.

Besides Lead-Acid battery, the battery cell (30) can be Li-ion battery, Li_{w}FeₓP2O_{y} battery, or Li-ion Polymer battery, etc. One to ten of the above battery cells can be packaged to be a battery cell (30) of the BMS battery unit (40). In addition to the inter communication in DESCS system, the BMS battery unit (40) can also perform its local control and monitoring to ensure the safety of battery cell.

To sum up, the Distributed Energy Storage Control System of the present invention is capable of attaining the following purposes and results while meeting patentability elements of novelty and progressiveness of a patent:
1. The present invention discloses a Distributed Energy Storage Control System (DESCS). The system is comprised of multiple BMS battery units (40). Several BMS battery units are series connected to form the basic series battery unit and several series battery unit are then parallel connected to form a series-parallel battery system. The DESCS system is formed by several series-parallel battery systems. Each DESCS system is comprised of a DESCS main controller, a set of DESCS transmission interface, several series-parallel controllers, several series-parallel transmission interfaces, and several series battery units. The BMS battery unit is comprised of a smart battery unit, a charge bypass circuit, a discharge bypass circuit, a charge bypass path control switch, a charge bypass load resistor, a discharge bypass path control switch, and a super capacitor. The smart battery unit is comprised of a controller (20), a battery cell, and a sensor switch device (charge path control switch and discharge path control switch). The controller is comprised of a microcontroller unit, a series-parallel transmission interface, an isolated transmission interface, a wireless transmission interface, a display unit, a data access unit, a synchronization unit, and a real time clock. The whole system is configured to be a master-slave manage/control system.
2. The present invention discloses both variable quantity of series connected battery and variable quantity of parallel connected battery strings. The variation in amount depends on the requirement of the system under a specific series-parallel connected configuration and is predefined before system constructed. (The scale of stored energy is flexible.)
3. The present invention discloses that some of the series-parallel connected systems can be independent specific power systems in this SESCS. A specific power system has its own system power/load bus bar (61) and system voltage reference line (62). The DESCS main controller (70) determines the specific voltage system for each series-parallel controller (60). All the series-parallel connected systems can be combined to form a power system of single voltage of course. (Diversified output supply voltages for the power system.)
4. The present invention discloses an active discharge bypass control structure. In a configuration of series connected battery system, the discharge bypass path provides a route to divert the discharge current from flowing through the low capacity or fault batteries to get rid of the safety problem caused by a reverse charge on the low capacity or fault batteries. The old technologies for series connected battery structure do not provide with the discharge bypass control circuit. Because of the over discharge protection mechanism for every single battery, the series connected battery string has limited its maximum discharge capacity to the one battery with lowest capacity for old technologies. After the activation of the discharge bypass mechanism of present invention, the discharge current for the whole battery string has a route to keep it to flow through and the capacity will not to be limited by a lower capacity or a fault battery. Every battery cell of a series connected battery string will fully make use of its energy stored and this is the most efficiency way of series battery discharge application. The more batteries a series battery system has, the more discharge efficiency advantages of this remarkable invention has. (Discharge efficiency of series connected battery system substantially increased. Maximum storage and application of energy.)
5. The present invention discloses a super capacitor that is parallel connected with the battery between the positive terminal (B+) and negative terminal (B−) of the battery. While the discharge path had turned off and the discharge bypass path has not turned on yet, the energy contained in this super capacitor sustains the discharge during the switching period. During switching on the discharge bypass mechanism for the series battery system, the present invention ensures that the power supply of this system will get rid of the power dip or interruption conditions. (Series connected battery set will get rid of the power dip or interruption conditions caused by the switching on of discharge bypass switch.)
6. The present invention discloses a series-parallel energy storage system configured with knife/overload protection switches. Through the knife switch every series battery unit can make choice of being charged/discharged via the common route of system or being charged/discharged via an independent route. In this system there can be some of the series battery units (50) in discharge mode and some in charge mode simultaneously. After one knife/overload protection switch (47) is switched off, the other series battery units (50) in the series-parallel system continue to carry out their charge/discharge process. This provides the system with a capability of on-line maintenance for the series battery unit (50) while the system is running uninterrupted. When a series battery unit (50) is repaired or replaced, it can be directly bond to the series-parallel system power/load bus bar (61) to perform the charge/discharge process while the voltage/capacity allowed. Also, it can be charged or discharged via the external path (63) to a balanced voltage for the system at first and then parallel connected to the series-parallel battery system. In a large-scale energy storage system, this feature provides convenience and flexibility for the operation of maintenance and installation. (System with flexible charge/discharge feature and high maintainability and installation convenience.)
7. The present invention discloses a design of external path. This provides the feasibility for each series battery unit to be independently charged with different power sources. The suitable independent charging power supply source can be a power appropriate regulated from the output of a public power plant, an alternator on vehicle, a solar energy power tower, a thermal-electric generator, a wind/hydraulic power generator, or from the other device which transfers energy to electric power, etc. (Diversified charging power supplies.)
8. The present invention discloses that a series-parallel controller (60) controls the output voltage/current of power source (64) via an energy regulator (65) to charge the series battery units (50) with constant voltage (CV) charge mode or with constant current (CC) charge mode. According to the power supply capacity of the power source (64) and upper/lower limits of the charge/discharge voltage and current of each series battery unit (50), the series-parallel controller (60) allots the charge current to groups of series battery units (50) in turn. (A flexible charging sequence determined by software for the charge of groups of series battery units in turn. )
9. The present invention discloses two methods to charge every battery in the DESCS system to the maximum capacity. The first one is to realize it through charge bypass control of the BMS battery unit (40) and voltage control of the charger. The other one is to realize it through voltage control of the charger only. (Selectivity of method to charge batteries to the maximum capacity.)
10. The present invention discloses that in the series battery unit (50) system, a concise bonding and connecting method between the BMS battery units simplifies the wiring of the system and the processing of the energy. Moreover, the system possesses the flexibility of configuration changing. (Concise wiring and flexibility of configuration change.)
11. The present invention discloses a wireless configuration for the system. The wireless devices in a series battery unit are able to connect with each other to for ma piconet in an ad-hoc manner. Multiple related piconets join together to form a larger network of scatternet in an ad-hoc manner, too. The wireless devices of the DESCS main controller (70) and several series system controllers (40′) form a piconet. The DESCS main controller (70) is the master controller in this piconet. The wireless devices in each series battery unit (50) also form a piconet and the master controller in this piconet is the series system controller (40′). The series system controller (40′) connects these two piconets. The role of the series system controller (40′) is a slave for the upper layer network and changed to be a mater for the lower layer network. Under the present of wireless configuration, the signal cable wirings between series system controller (40′) and BMS battery units (40) or between series system controllers (40′) and the DESCS main controller (70) are all removed. The concise configuration and removal of signal cable connections in installation expedite the maintenance of the system. (Apply the wireless configuration to simply the wiring of the system and expedite the maintenance of the system.)

I claim:

1. A Distributed Energy Storage Control System (DESCS) comprises multiple BMS battery units. Several BMS battery units are series connected to form the basic series battery unit and several series battery unit are then parallel connected to form a series-parallel battery system. The DESCS system is formed by several series-parallel battery systems.
Each DESCS system is comprised of a DESCS main controller, a set of DESCS transmission interface, several series-parallel controllers, several series-parallel transmission interfaces, and several series battery units. Each battery in the series battery unit is provided with discharge bypass path to ensure the fully use of the energy stored in the battery and to prevent the danger of over heat or explosion of battery caused by reverse charge during the discharge process.
The BMS battery unit is comprised of a smart battery unit, a charge bypass circuit, a discharge bypass circuit, a charge bypass path control switch, a charge bypass load resistor, a discharge bypass path control switch, and a super capacitor. The BMS battery unit is provided with a mechanism of discharge bypass path management for a single battery. The super capacitor ensures an uninterrupted power output of the battery during the period of the discharge bypass path activating.
The smart battery unit is comprised of a controller (20), a battery cell, and a sensor switch device (charge path control switch and discharge path control switch).
The controller is comprised of a microcontroller unit, a series-parallel transmission interface, an isolated transmission interface, a wireless transmission interface, a display unit, a data access unit, a synchronization unit, and a real time clock. The BMS battery unit communicates with and controlled by the upper layer controller via the series-parallel transmission interface. The communication and controlling between BMS battery units are accomplished by the isolated transmission interface. The wireless transmission interface can in place of all wirings in the DESCS system and can bring about a more concise system structure and provide an easy way for maintenance.

2. The discharge bypass path mechanism as claimed in claim 1, wherein the path provides a short circuit route from positive end to negative end of the battery. After the fault battery or the battery which is discharged to its lower limit is isolated, this path provides the series battery unit a low impedance route for current flow. When fault battery or battery with cease discharge presents in a series battery string, this path keeps the series battery unit supplying the power continuously.

3. The discharge bypass path mechanism as claimed in claim 2, wherein a series connected battery set using the discharge bypass path mechanism can make use of all the energy stored in every battery in the series battery unit and can promote the discharge efficiency of the distributed energy storage system substantially so that provides a maximum energy storage and application.

4. The discharge bypass path mechanism as claimed in claim 2, wherein during the discharge process of a series battery unit, the low capacity batteries or fault batteries are isolated so that prevent being reverse charged and avoid the danger of overheated battery or explosion.

5. The super capacitor as claimed in claim 1, wherein starting up a discharge bypass path, the discharge path of a battery cell must be switched off before the bypass path be switched on to avoid a hazardous huge transient discharge current and to protect the battery from damage and prolong the service life. Time is required to activate the discharge bypass mechanism, however, and the super capacitor sustains the required output power during this period of time and then keeps a continuing power supply without current interruption or dip for the whole series battery unit.

6. The series-parallel system as claimed in claim 1, wherein in addition to the bulk series-parallel system charge/discharge path, an independent external charge/discharge path is also provided for each series battery unit to be charged/discharged separately.

7. The series-parallel system as claimed in claim 6, wherein every series-parallel system in the DESCS can be an independent unique power system which has its unique system power/load bus bar (61) and voltage reference line (62). The specific voltage system of the series-parallel controller (60) is determined by the DESCS main controller (70). Also, all of the series-parallel system can be combined to form a power system of single output voltage. The power supply voltages of a DESCS can be diversified.

8. The series-parallel system as claimed in claim 6, wherein the series-parallel controller can flexibly determine the charging manner for the series battery units to be charged in turn by software in according to the conditions of the output power/energy of the power source, maximum or minimum charging current of each battery, etc.

9. The external charge/discharge path as claimed in claim 6, wherein is a knife switch and overload protection switch. This switch provides the power source terminal of the series battery unit to switch its charge/discharge path alternate series-parallel system path and respective external path. The external charge/discharge path provides the series battery an individual management of charge and discharge. Through the external path, when a battery is needed to be repaired or replaced, a series battery unit (50) can be detached from the series-parallel system for maintenance purpose. After the maintenance, the series battery unit can join to the charge/discharge process of the series-parallel system by directly parallel connected to the system or it can be charged or discharged to the same voltage of the system for a balance purpose at first and then parallel connected to the system.

10. The external charge/discharge path as claimed in claim 6, wherein the series battery unit being switched to the external charge/discharge path can be charge/discharge separately. The power sources for charging can be various power sources that voltages are regulated or transformed properly. The charging power source is diversified.

11. The separate maintenance process via the external path of a series battery unit as claimed in claim 1, wherein the maintenance process will proceed directly and will not interrupt the charge/discharge process of the distributed energy storage control system. This provides the system a flexible and convenience way of maintenance.

12. The wireless transmission interface as claimed in claim 1, wherein a scattered wireless network is configured to be a master-slave control system replacing all wirings of signal transmission interface and providing a concise configuration for the DESCS system. Because of the removal of physical signal wirings, the installation for a battery is only required to take care of the connection of positive and negative terminals. It provides a more simple and easy way to maintain the system.

13. The distributed energy storage control system as claimed in claim 1, wherein the amount of BMS battery units in a series battery unit is flexibly expandable and the amount of parallel connected series battery units in a series-parallel battery system is also expandable. The total energy stored in one distributed energy storage control system can be flexibly expanded in accordance with the actual system scale required.
